(19) United States
(12) Patent Application Publication
(10) Pub. No.: US 2025/0375075 A1
(43) Pub. Date: Dec. 11, 2025

(54) ROBOT

(71) Applicant: Dyson Technology Limited, Malmesbury Wiltshire (GB)

(72) Inventors: Frederick Jack WHITTEN, Bristol (GB); David Alan MILLINGTON, Swindon (GB); David Stuart COLE, Bath (GB)

(21) Appl. No.: 18/877,336

(22) PCT Filed: Jun. 16, 2023
(86) PCT No.: PCT/IB2023/056253

§ 371 Date: Dec. 20, 2024

(30) Foreign Application Priority Data
Jun. 23, 2022 (GB) 2209222.5

(51) Int. Cl. A47L 9/00; B62D 57/032

(52) U.S. Cl. CPC A47L 9/009; B62D 57/032; A47L 2201/02

(57) ABSTRACT

A robot is disclosed herein. The robot includes a body with an underside and a plurality of legs for supporting the body above a support surface. A housekeeping module is carried by the body, and during operation of the robot, the housekeeping module performs a housekeeping operation. The housekeeping module is extendible from the underside of the body.

### FIELD OF THE INVENTION

The present invention relates to a robot for performing a housekeeping operation.

### BACKGROUND

Robots for performing a housekeeping operation are known. For example, it is known to provide robot vacuums for vacuum cleaning of floors. Such robot vacuums may be utilised in a domestic environment or a commercial environment, e.g. in a hotel.

Known robot vacuums may have a generally flat body with a brush roll carried in the body. This configuration provides a ‘biscuit tin’ shape to the robot and may enable the robot to access restricted spaces, particularly spaces with low clearance, for example in order to vacuum under furniture. Hence, ‘biscuit tin’ robots may provide for improved access. However, the traversal capabilities of ‘biscuit tin’ robots may be limited, such as may be needed for traversing a step.

The utility of robots, particularly ‘biscuit tin’ robots, is therefore limited as a result of limited traversal capabilities

### SUMMARY OF THE INVENTION

The present invention relates to a robot with legs, such as a quadruped, and an extendible housekeeping module which may be described as being carried in an “underslung” configuration. The “underslung” configuration may help to improve the traversal capabilities of the robot, yet by extending the housekeeping module, the robot may in use reach out with the housekeeping module and perform a housekeeping operation.

Robots with legs are known for their comparatively improved traversal capabilities. However, such robots are generally larger than their ‘biscuit tin’ counterparts and have correspondingly reduced access to tight spaces. This issue may be further compounded as equipment is commonly mounted onto the top of the robot body, so as not to interfere with locomotion, making the robots even taller. By contrast, a robot according to the present invention carries what may be described as an “underslung” housekeeping module. Moreover, the housekeeping module is extendible to improve performance of the housekeeping task as well as access and traversal.

According to a first aspect of the invention, there is provided a robot comprising a body and a plurality of legs for supporting the body above a support surface, such as a floor or the ground. The robot further includes a housekeeping module carried by the body, wherein the housekeeping module is configured to perform a housekeeping operation, such as vacuuming. The housekeeping module is extendible from an underside of the body.

Herein, a housekeeping operation may be understood as an operation for cleaning or maintaining a domestic or commercial environment, which could be indoors or outdoors. Exemplary housekeeping operations may include, for example, a vacuum cleaning operation (e.g. vacuuming the support surface on which the robot is standing), a wet cleaning operation (e.g. mopping or scrubbing a surface, e.g. the support surface on which the robot is standing), a watering operation (e.g. watering grass or other plant), a lawnmowing operation, a leaf blowing operation.

The underside of the body may be understood as a surface of the body which faces a support surface when the robot is on the support surface with the legs supporting the body above the support surface.

The body may have a front end facing in a forward direction and a rear end facing in a rearward direction. The body may include a head at the front end of the body.

The robot may be configured to extend the housekeeping module from the underside of the body by tilting the housekeeping module relative to the underside of the body or by translating the housekeeping module relative to the body, or a combination of tilting and translating.

The robot may be configured to tilt the housekeeping module relative to the underside from a stowed orientation (or ‘first orientation’) to a deployed orientation (or ‘second orientation’).

In the stowed orientation, a clearance space may be formed between the housekeeping module and the support surface. Tilting the housekeeping module from the stowed orientation to the deployed orientation may cause at least a portion of the housekeeping module (e.g. a distal end of the housekeeping module) to be extended towards the support surface.

Traversal capabilities of the robot may be improved when the housekeeping module is in the stowed orientation, while performance of the housekeeping operation may be improved when the housekeeping module is in the deployed orientation.

The robot may be configured to assume a lowered configuration by lowering the body towards the support surface (e.g. by manipulating the legs).

Lowering the body towards the support surface may urge the housekeeping module against the support surface. Urging the housekeeping module against the support surface may cause the housekeeping module to tilt from the deployed orientation to the stowed orientation. Thus, by lowering the body towards the support surface, the housekeeping module may be returned from the deployed orientation to the stowed orientation.

In other examples, the housekeeping module may be returned from the deployed orientation to the stowed orientation via a user manually tilting the housekeeping module from the deployed orientation to the stowed orientation.

The housekeeping module and the body may be configured to cooperate to releasably lock in the stowed orientation (e.g. after the housekeeping module has been returned from the deployed orientation to the stowed orientation, e.g. via lowering of the body towards the support surface, or manually by a user).

By locking the housekeeping module in the stowed orientation, the housekeeping module may be maintained in the stowed orientation. Hence, the housekeeping module may be extendible from the stowed orientation to the deployed orientation, and returnable from the deployed orientation to the stowed orientation. Thereby traversal capabilities may be optimised prior to and following performance of the housekeeping operation.

The robot may be configured to enter a first operational mode by tilting the housekeeping module to the deployed orientation to cause the (e.g. a distal end of the) housekeeping module to engage the support surface.

For certain examples of housekeeping operations, it may be preferable for (e.g. a distal end of) the housekeeping module to engage the support surface with the housekeeping module, e.g. when vacuuming the support surface. Causing the housekeeping module to engage the support surface may therefore improve performance of such housekeeping operations. However, this might not be required for all housekeeping operations, e.g. watering plants or spraying a surface with cleaning fluid.

The robot may be configured to translate the housekeeping module along the body, such as along a longitudinal axis of the body, between a retracted position (or ‘first position’) and an extended position (or ‘second position’).

The robot may be configured to translate the housekeeping module between the retracted position and the extended position when the robot is in the first operational mode. This may cause the housekeeping module to move along the support surface.

By causing the housekeeping module to move along the support surface, performance of the housekeeping operation may be improved. For example, the housekeeping operation may thus be performed across a greater area of the support surface. This may enable the robot to remain stationary while performing the housekeeping operation in a specific area. Also, this may enable the housekeeping operation to be performed in an area otherwise inaccessible to the robot, with the robot reaching said area by translating the housekeeping module.

A length of the robot along the longitudinal axis may be greater when the housekeeping module is in the extended position than when the housekeeping module is in the retracted position.

The robot may be configured to translate the housekeeping module to the extended position so as to increase the extent by which the housekeeping module extends from the front end (or ‘first end’) of the body.

The robot may be configured to assume a sitting configuration in which the body is tilted (e.g. by manipulating the legs) such that the front end (e.g. head) of the body is supported at higher elevation than the rear end (or ‘second end’) of the body relative to the support surface.

The robot may be configured to have the housekeeping module in the extended position when the robot is in the sitting positing. For avoidance of any doubt, this may be achieved by the robot assuming the sitting configuration, then translating the housekeeping module from a retracted position to the extended position, or by the translating the housekeeping module from a retracted position to the extended position, then assuming the sitting configuration, or by the robot translating the housekeeping module from a retracted position to the extended position at the same time as assuming a sitting configuration.

By having the housekeeping module in the extended position when the robot is in the sitting configuration, manual access to the housekeeping module may be improved. In particular, it may not be necessary for a user to reach under the body when accessing the housekeeping module. Thus, user convenience and safety may be improved.

The robot may be configured to translate the housekeeping module to the extended position (e.g. when the robot is in the sitting configuration) to expose to user access a release mechanism for releasing the housekeeping module.

By exposing the release mechanism when the housekeeping module is in the extended position, user convenience and safety may be improved. Convenience and safety may be particularly improved where the robot translates the housekeeping module to the extended position and assumes the sitting configuration to expose the release mechanism.

The robot may be configured to enter a second operational mode by assuming the lowered configuration and translating the housekeeping module to the extended position.

By assuming the lowered configuration and translating the housekeeping module to the extended position, the robot may extend the housekeeping module into a restricted space into the which the entire robot would not fit. For example, vacuuming under furniture may thus be possible even where the entire robot is too tall to fit thereunder.

The robot may comprise a port configured to releasably receive the housekeeping module. The housekeeping module may be exchangeable for one or more other housekeeping modules, e.g. using a module station as described below.

The plurality of legs may comprise a pair of front legs facing in a forward direction.

The housekeeping module may include a module body and a module head. The module body may be arranged to extend in the forward direction through a gap between the pair of front legs. The module head may be located in front of the pair of front legs. The module head may be wider than the gap between the pair of legs.

Arranging the module head in this way may help avoid the width of the legs being dictated by the size of module head (or vice versa), thereby permitting arrangements in which a module head is wider than the gap between the legs (as might maximise the performance of, for example, a vacuuming operation, without inhibiting the traversal performance of the robot).

The robot may be a quadruped. That is to say, the robot may have four legs.

Each leg of the robot may include a leg joint that can bend.

The robot may be configured to lower the body towards the support surface by bending the leg joints, thereby assuming the lowered configuration.

The leg joint of each leg of the robot may be arranged to move inward with respect to the body when the robot assumes the lowered configuration.

By moving the leg joints inward when assuming the lowered configuration, lowering the body may not increase the extent of the robot. Otherwise outward moving leg joints would be translated away from the body when lowering the body, which may increase the longitudinal extent of a robot.

The robot may have a pair of rear legs facing in a rearward direction.

The robot may be configured to tilt the body such that the front end (e.g. head) of the body is supported at higher elevation than a rear end (or ‘second end’) of the body relative to the support surface by bending the leg joints of the pair of rear legs (or by straightening the front legs), thereby assuming the sitting configuration.

Other leg configurations which do not include leg joints but which can be manipulated to allow the robot assume the lowered configuration and/or sitting configuration can also be envisaged by a skilled person in light of the disclosure herein. For example, the legs could be pivoted and/or telescopic, whereby pivoting and/or telescopically extending/retracting the legs could be performed to allow the robot to assume the lowered configuration and/or sitting configuration.

In some examples (not shown herein), one or more legs may include a wheel to assist with movement of the robot.

The housekeeping module may, for example, be provided as:
a vacuum cleaning module configured to perform a vacuum cleaning operation (e.g. vacuuming the support surface on which the robot is standing);
a wet cleaning module configured to perform a wet cleaning operation (e.g. mopping or scrubbing a surface, e.g. the support surface on which the robot is standing);
a watering module configured to perform a watering operation (e.g. watering grass or other plant);
a lawnmowing module configured to perform a lawnmowing operation;
or a leaf-blowing module configured to perform a leaf blowing operation.

According to a further aspect of the invention, there may be provided a robot system including a robot as described above and a module station configured to receive the housekeeping module. The robot system may include one or more other housekeeping modules.

The robot may be configured to approach the module station and release the housekeeping module (e.g. from the above described port) so as to transfer the housekeeping module to the module station. The robot may be configured to do this without requiring any user manipulation of the housekeeping module or module station.

The module station and/or robot may be configured to transfer a new housekeeping module to the robot (e.g. such that the above described port of the robot receives the new housekeeping module) and the other housekeeping module at the module station. The module station and/or robot may be configured to do this without requiring any user manipulation of the housekeeping module or module.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 is a perspective view of an exemplary robot.

FIG. 2 is a sideview of the robot.

FIG. 3 is another sideview of the robot.

FIG. 4 is yet another sideview of the robot.

FIG. 5 is a perspective view of the robot in an environment.

FIG. 6 is a perspective view of the robot in another environment.

FIG. 7 is a perspective view of the robot in yet another environment.

FIG. 8 is a partial perspective view of the robot.

FIG. 9 is a sideview of the robot.

FIG. 10 is a perspective view of the robot with a first housekeeping module.

FIG. 11 is a perspective view of the robot with a second housekeeping module.

FIG. 12 is a sideview of the robot and a module station.

FIG. 13 is a perspective view of the robot showing a first mechanism for the housekeeping module.

FIG. 14 is a perspective view of the robot showing a second mechanism for the housekeeping module.

FIG. 15 is a perspective view of the robot showing a third mechanism for the housekeeping module.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The present disclosure relates to a robot for performing a housekeeping task. Exemplary housekeeping tasks include vacuum cleaning. The housekeeping task may be carried out in a domestic environment or in a commercial environment; indoors or outdoors.

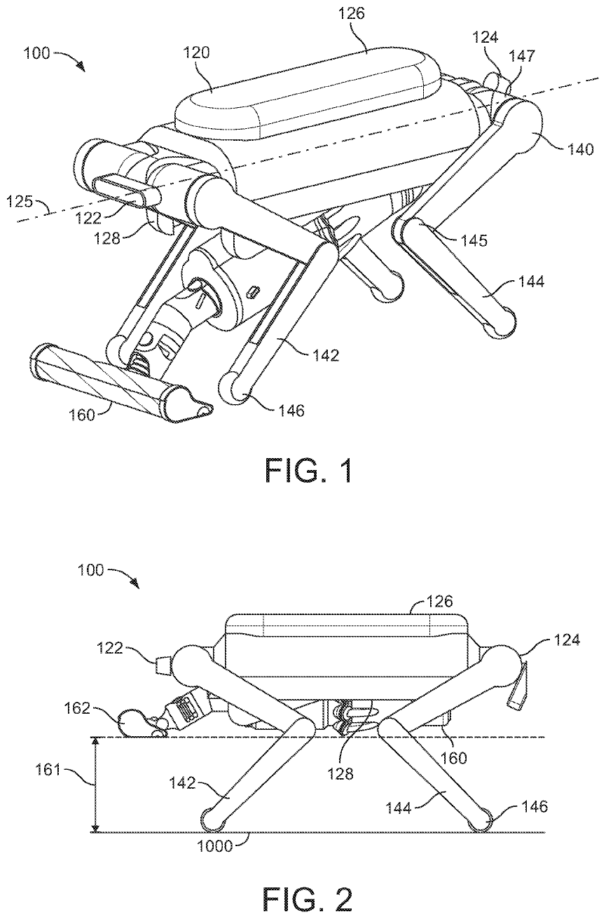

FIG. 1 is a perspective view of an exemplary robot 100. The robot 100 comprises a body 120 (or ‘torso’) and a plurality of legs 140 for supporting the body 120. In use, the legs 140 carry the body 120 above a support surface 1000, such as a floor or the ground.

The body 120 has a front end 122 (or ‘first end’) and, opposite thereto, a rear end 124 (or ‘second end’). The body 120 is generally elongated. A longitudinal extent of the robot 100 is delimited by the first end 122 and the second end 124, and the body 120 defines a longitudinal axis 125.

The body 120 has an upper side 126 and, opposite thereto, an underside 128. In use, the underside 128 faces toward the support surface 1000 on which the robot 100 is carried by the legs 140.

The robot 100 includes a housekeeping module 160. The housekeeping module 160 is configured to perform a housekeeping operation, which in this example is vacuum cleaning. In this example, the housekeeping module 160 is smaller in width and height than the body 120 of the robot 100.

The housekeeping module 160 is carried by the body 120 and is extendible from the underside 128 of the body 120. In FIG. 1 the housekeeping module 160 is shown extended from the underside 160 and engages the support surface 1000.

By means of the plurality of legs 140, the robot 100 is capable of moving around in order to perform the housekeeping operation in different locations or whilst moving around. In this example, the legs 140 are attached to the body 120 at locations between the upper side 126 and the underside 128.

A pair of front legs 142 is provided at the front end 122, and a pair of rear legs 144 is provided at the rear end 124. The exemplary robot 100 is thus a quadruped, as it has four legs.

The legs 140 are articulated, with each leg 140 having a leg joint 145. The leg joint 145 enables bending and extending of the corresponding leg 140. The leg 140 is articulated about the body 120 by means of a proximal joint 147 joining the leg 140 to the body 120.

Each leg 140 terminates in a foot 146. In use, the feet 146 engage the support surface 1000.

Quadruped robots whose legs have leg joints are well known, as are the mechanisms for allowing the quadruped robot to traverse its surrounding through operation of the legs, and such operations need not be described in more detail herein.

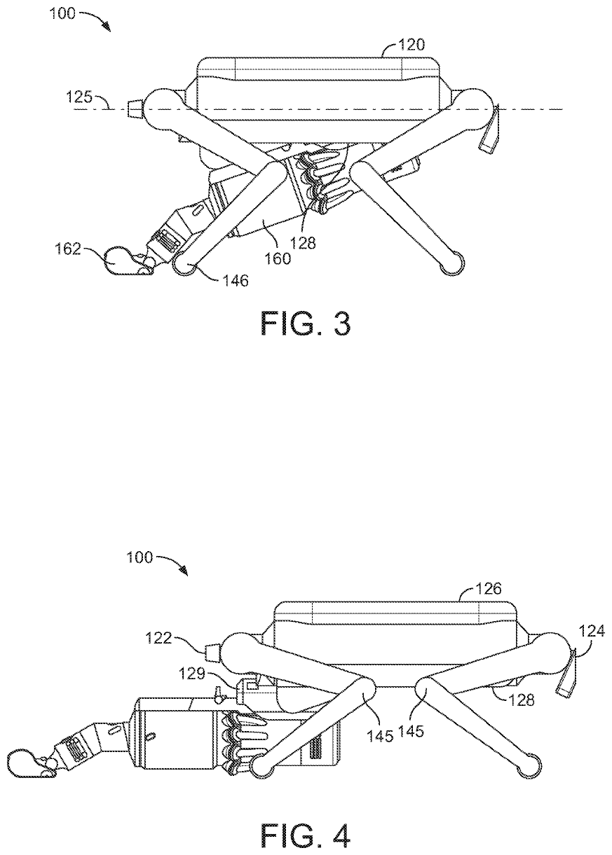

FIGS. 2, 3 and 4 illustrate extending of the housekeeping module 160. FIG. 2 shows the housekeeping module 160 stowed at the underside 128 of the body 120; FIG. 3 shows the housekeeping module 160 extended by tilting the housekeeping module 160 from the underside 128;

FIG. 4 shows the housekeeping module 160 extended by translating the housekeeping module 160 along the body 120.

When the housekeeping module 160 is in a stowed orientation, as shown in FIG. 2, a clearance space 161 is formed between the housekeeping module 160 and the support surface 1000. In other words, in the stowed orientation the whole housekeeping module 160 is carried at an elevation relative to the support surface 1000.

The housekeeping module 160 is tilted relative to the underside 128 from the stowed orientation to a deployed orientation, shown in FIG. 3. Tilting the housekeeping module 160 to the deployed orientation causes at least a portion of the housekeeping module 160 to be extended towards the support surface 1000. In this example, a module head 162 of the housekeeping module 160 extends to and engages the support surface 1000.

When the housekeeping module 160 is tilted to the deployed orientation, the housekeeping module 160 is extended towards the feet 146. More particularly, the module head 162 is closer to the feet 146 of the front legs 142 when in the deployed orientation than when the housekeeping module 160 is in the stowed orientation.

The housekeeping module 160 is translated along the longitudinal axis 125 of the body 120 between a retracted position and an extended position. The retracted position is shown in FIG. 2, while the extended position is shown in FIG. 4.

A length of the robot 100 along the longitudinal axis 125 is greater when the housekeeping module 160 is in the extended position than when the housekeeping module 160 is in the retracted position. In other words, the robot 100 is longer when the housekeeping module 160 is in the extended position.

When in the extended position, the extent by which the housekeeping module 160 extends from the front end 122 of the body 120 is increased. In the retracted position, the module head 162 extends from the front end 122 by a first extent. In the extended position, the module head 162 extends from the front end 122 by a second extent. The second extent is greater than the first extent.

The robot 100 is configured to assume a lowered configuration. The lowered configuration is shown in FIG. 4, while FIG. 2 shows a traverse configuration (or ‘non-lowered configuration’). The robot 100 lowers the body 120 towards the support surface 1000 to assume the lowered configuration. In this example, the robot 100 causes the legs 140 to bend about the leg joints 145 in order to assume the lowered configuration.

The feet 145 of the legs 140 are located closer to the underside 128 of the body 120 when in the lowered configuration than when in the traverse configuration. That is to say, the robot 100 draws in the feet 145 when assuming the lowered configuration.

By lowering the body 120 onto the housekeeping module 160, the robot 100 may return the housekeeping module 160 to the stowed orientation and lock the housekeeping module 160 therein. More particularly, the robot 100 is configured to lower the body 120 towards the support surface, thereby urging the housekeeping module 160 against the support surface 1000. In turn, urging the housekeeping module 160 against the support surface 1000 causes the housekeeping module 160 to tilt from the deployed orientation to the stowed orientation. Thus, by lowering the body 120 towards the support surface 1000, the housekeeping module 160 is returned to the stowed orientation.

The housekeeping module 160 and the body 120 are configured to cooperate to releasably lock in the stowed orientation. In this example, a physical latching mechanism secures the housekeeping module to the body 120.

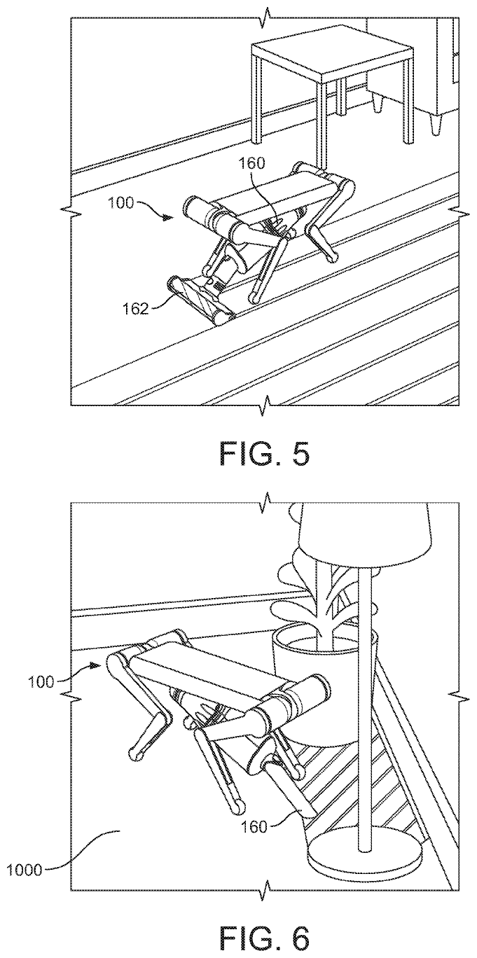

FIGS. 5 and 6 illustrate a first operational mode of the robot 100. FIGS. 5 and 6 are perspectives view of the robot 100 performing the housekeeping action in a particular environment.

The robot 100 enters the first operational mode by tilting the housekeeping module 160 to the deployed orientation to cause the housekeeping module 160 to engage the support surface 1000. In this example, the module head 162 engages the support surface 1000.

As shown in FIG. 5, the robot 100 traverses a first area when in the first operational mode in order to carry out the housekeeping operation in said area. This may be particularly suitable for open spaces.

As shown in FIG. 6, the robot 100 accesses a second area when in the first operational mode by translating the housekeeping module 160 into said area. Thus, the robot 100 accesses the second area without the whole robot 100 entering the second area. This may be particularly suitable for restricted spaces in which the robot 100 may have difficulties manoeuvring, such as between furniture.

In other words, plunging the housekeeping module 160, which may be smaller in width and height that the body 120, may allow the robot 100 to stand still outside of an obstacle whilst still reaching and cleaning under or between the obstacle.

As is described below, the module 162 may be wider than the leg spacing or wider than the body 120, but in this case may be positioned forwards of the legs 140.

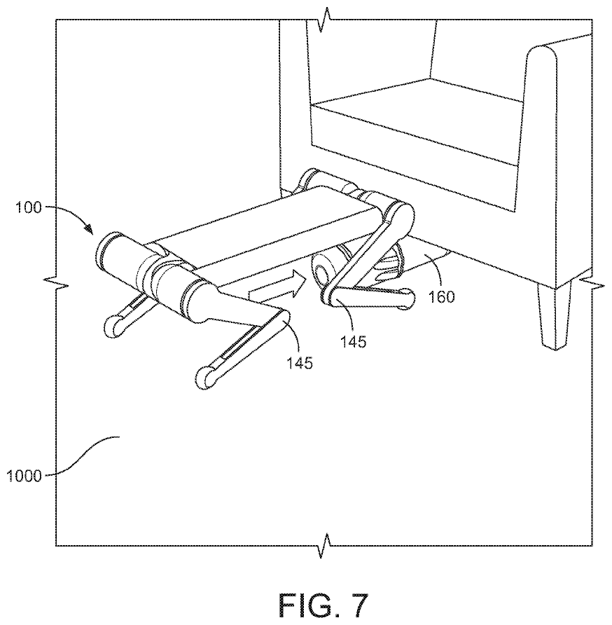

FIG. 7 is a perspective view of the robot 100 in another environment, illustrating a second operational mode of the robot 100.

The robot 100 assumes the lowered configuration and translates the housekeeping module 160 towards the extended position in order to vacuum in a space with low clearance. In this example, the space under a furniture item is so restricted that the body 120 of the robot 100 would not fit, but the housekeeping module 160 is extendible into said space. By repeatedly extending and withdrawing the housekeeping module 160, the robot 100 performs the housekeeping operation in this restricted space.

The leg joints 145 are arranged inwardly with respect to the body 120. When the robot 100 assumes the lowered configuration, the leg joints 145 are moved inward relative to the body 120. Thus, the leg joints 145 do not extend beyond the body 120 when assuming the lowered configuration, which would necessitate space for accommodating the legs 140 so extended and such space may in use not be available.

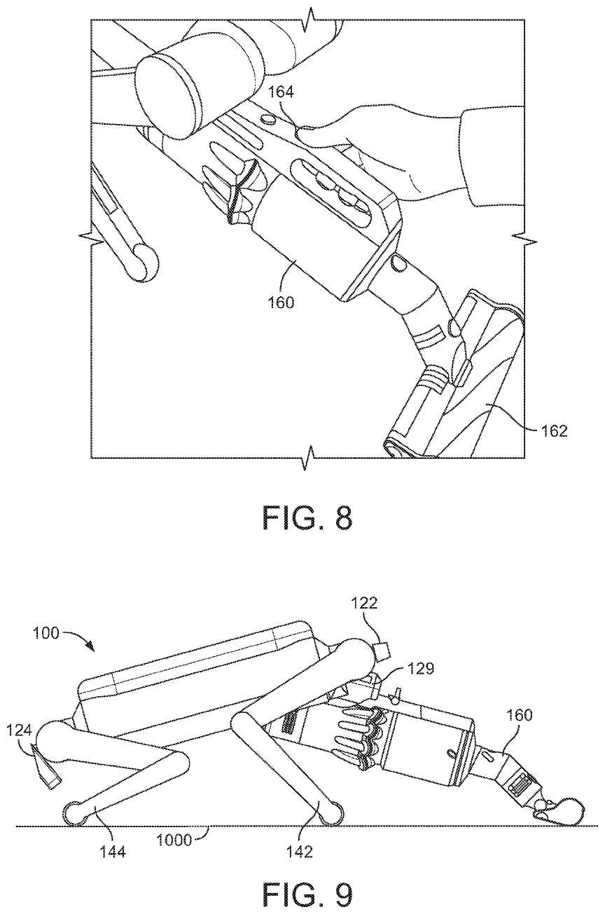

FIGS. 8 and 9 illustrate the housekeeping module 160 being removed. FIG. 8 is a perspective view of the robot 100 with the housekeeping module 160 being removed from the body 120 by a user. FIG. 9 shows a configuration which the robot 100 may assume for removal of the housekeeping module 160.

The robot 100 comprises a port 129 configured to releasably receive the housekeeping module 160. The port 129 provides a mechanical interface by means of which the housekeeping module 160 is secured to the body 120, and from which the housekeeping module 160 can be released. Suitably, the robot 100 comprises a release mechanism 164 for releasing the housekeeping module 160. In this example, the release mechanism 164 is provided on the housekeeping module 160.

The robot 100 is configured to extend the housekeeping module 160 to the extended position for purposes of removing the housekeeping module 160. Thereby the release mechanism 164 is exposed to user access. Since the housekeeping module 160 is located underneath the body 120, this may make it difficult for the user to access in order to remove the module 160, e.g. to perform maintenance. However, by extending the housekeeping module 160, access may be improved. In particular, the user may not be required to reach under the body 120 of the robot 100.

In other words, the robot 100 may present the housekeeping module 100 to the user by plunging the housekeeping module 160 forwards, thereby positioning the housekeeping module in front of the robot 100. The robot 100 can then enter a stable state where power to the legs 140, e.g. the motors, is disabled. The release mechanism 164 of the module interface may then be actuated by the user conveniently and safely.

The robot 100 is further configured to assume a sitting configuration for purposes of removing the housekeeping module 160. In the sitting configuration, the front end 122 of the body 120 is supported at a higher elevation than the rear end 124. In this example, the robot 100 bends the rear legs 144, effectively kneeling, to assume the sitting configuration.

Upon removal of the housekeeping module 160 from the body 120, the housekeeping module 160 may be returned to the body 120, e.g. after performing maintenance. Alternatively, the housekeeping module 160 may be exchanged for a different housekeeping module 160 to be interfaced with the body 120. That is, the port 129 provides a common interface to which different housekeeping modules can attach.

Known quadruped robots can only typically perform a single function depending on the equipment attached. If another function is desired, then the equipment must be swapped out by a user before the robot can perform the secondary function. On certain known quadrupeds, this is a lengthy process involving multiple attachments. By contrast, the robot 100 may streamline this process, both in terms of user convenience and safety.

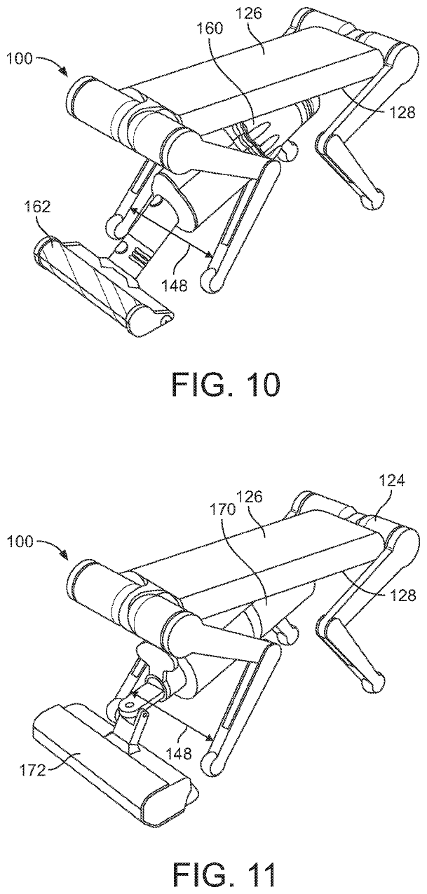

FIGS. 10 and 11 illustrate different housekeeping modules 160, 170. In this example, the housekeeping modules 160, 170 are interchangeable by means of the modular interface provided by the port 129.

Exemplary housekeeping modules 160, 170 may be configured for vacuum cleaning, wet cleaning (or ‘mopping’), watering, lawnmowing, and leaf-blowing. FIG. 10 shows the robot 100 with the housekeeping module 160 provided as a vacuum cleaning module, while FIG. 11 shows the robot 100 with a wet-cleaning module 170 for cleaning the support surface 1000, with a wet-cleaning head 172.

Depending on the housekeeping module equipped, the corresponding housekeeping operations may be carried out indoors, such as vacuum cleaning in a hotel, or outdoors, such as lawnmowing. Some housekeeping operations may be carried out indoors and outdoors, such as watering of plants in an office space or a garden.

In FIGS. 10 and 11, the module head 162, 172 is wider than a gap 148 between the front legs 142. Suitably, the module head 162, 172 is located in front of the front legs 142. Thus, the robot 100 can extend the housekeeping module 160 to the deployed orientation or the extended position.

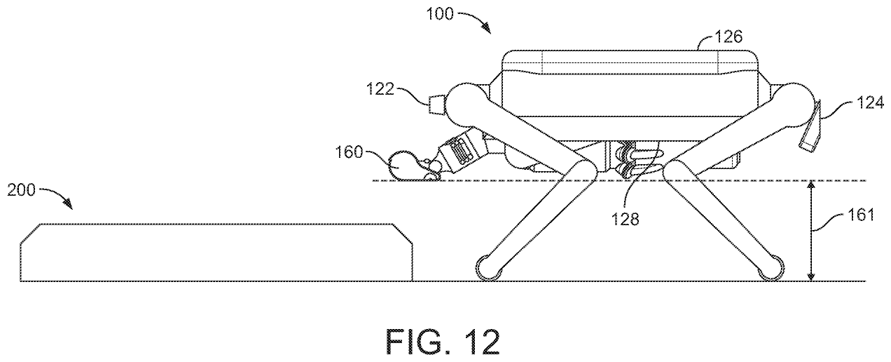

FIG. 12 shows the robot 100 and a module station 200 (or ‘docking station’ or ‘dock’) for receiving the housekeeping module 160.

The module station 200 is configured to receive the housekeeping module 160. The robot 100 in use approaches the module station 200 and releases the housekeeping module 160 to the module station 200. In this example, the robot 100 steps over the module station 200, lowers the housekeeping module 160 into the module station 200 and releases the housekeeping module 160.

The module station 200 may also be utilised for exchanging housekeeping modules 160, 170. That is to say, the robot 100 may release a first housekeeping module to the module station 200 and collect a second housekeeping module from the module station 200.

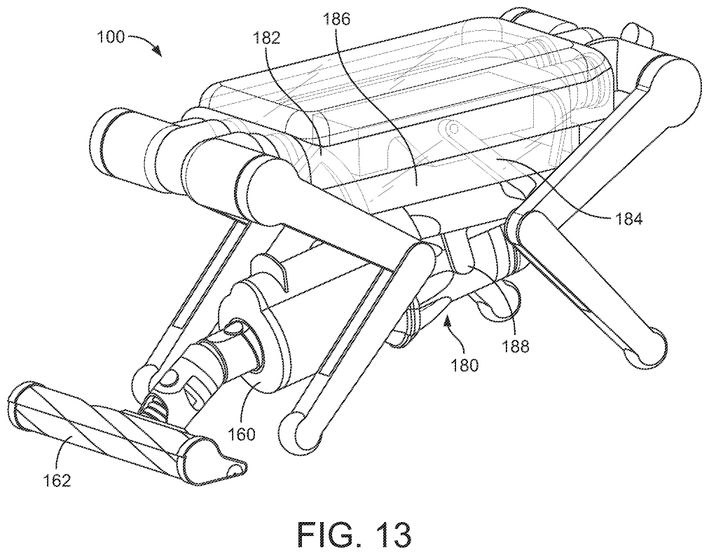

FIG. 13 is a perspective view of the robot 100, illustrating a mechanism 180 for articulating the housekeeping module 160. The mechanism 180 is provided as a four-bar linkage comprising two pairs of linkage members 182, 184 and a carriage 186. The carriage 186 is connected to the underside 128 by the linkage members 182, 184. By rotating the linkage members 182, 184, the carriage 186 is extendible from the underside 128 and returnable to the underside 128.

The carriage 186 comprises a passive pivot plate 188. The pivot plate 188 comprises the port 129 to which the housekeeping module 160 is attached, and is configured to pivot under the action of gravity. Accordingly, the housekeeping module 160 is tilted to the deployed orientation once released.

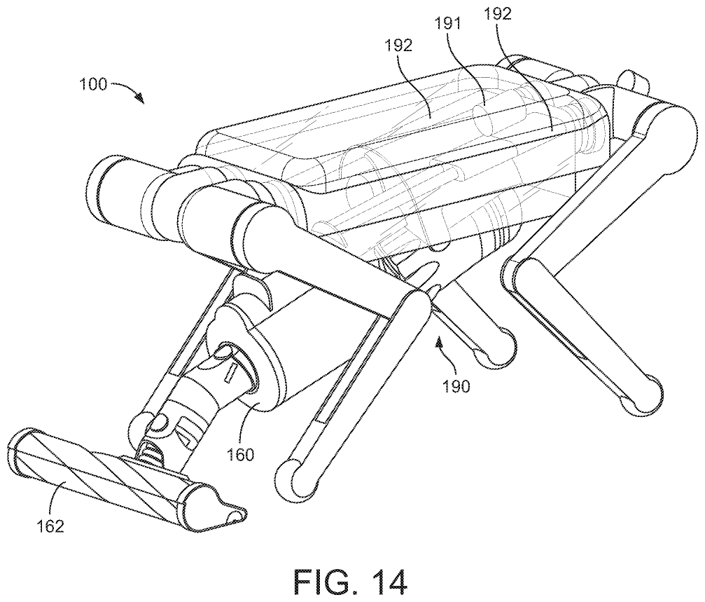

FIG. 14 is a perspective view of the robot 100, illustrating another mechanism 190 for articulating the housekeeping module 160. The mechanism 190 comprises a lead screw drive 191 for extending the housekeeping module 160. The housekeeping module 160 is translatable along a pair of linear rails 192.

The lead screw 191 is configured to move the housekeeping module 160 forwards and backwards. The lead screw 191 is also configured to lock and secure the module in the stowed orientation, by moving the housekeeping module 160 to a locked position wherein the housekeeping module 160 and the body 120 cooperate to lock.

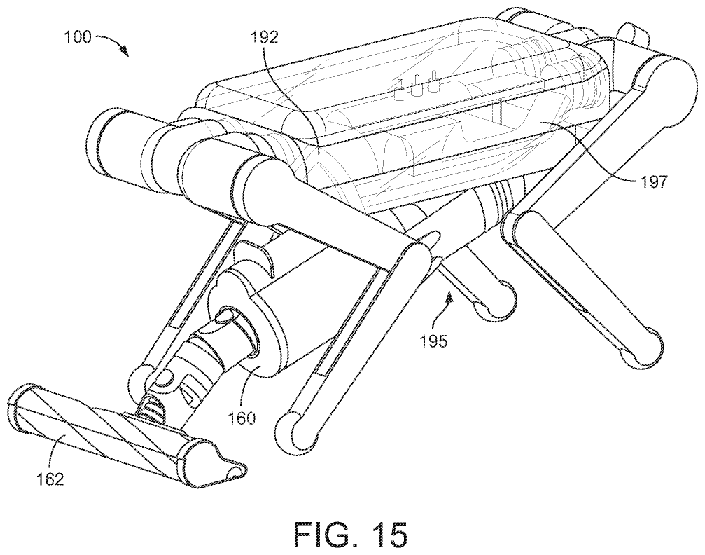

FIG. 15 is a perspective of the robot 100, illustrating yet another mechanism 195 for articulating the housekeeping module 160. The mechanism 195 comprises a pair of front pivot arms 196 and a rear guide track 197. The front pivot arms 196 are configured to actively lower the module head 162, 172 and ensure contact of the module head 162, 172 with the surface to be engaged.

The described robot 100 has numerous advantages as set out above. Here the following summary of some of these advantages is provided.

By plunging the housekeeping module forwards, the robot may be able to reach under obstacles and between obstacles that the body may not be able to reach. With a housekeeping module attached, the robot may be able to clean under and between more obstacles, increasing the coverage.

The robot does not need to navigate into tight gaps between obstacles and can remain clear of them whilst still cleaning under or between the obstacles. This makes a collision with the obstacle less likely and reduces the chance of the robot losing stability. Moreover, it is noted that navigating a quadruped robot between a narrow gap may require a high accuracy sensing and positioning system in order to avoid collisions which could cause instability.

The user is able to easily insert or remove a module without having to reach underneath the robot. The robot can be in a stable, unpowered state during user module exchange which may decreases the risk of injury, e.g. from moving parts.

The robot can perform multiple functions depending on the module that it has attached, e.g. vacuuming and mopping of floors.

The robot 100 described above has feet 145 provided as pads. Alternatively, feet comprising wheels may be provided.

The port 129 of the robot 100 is a mechanical interface which does not provide power or control to the housekeeping module 160. Alternatively, the port 129 may be utilised to provide power and/or control to the housekeeping module.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A robot, comprising:
a body with an underside;
a plurality of legs for supporting the body above a support surface;
a housekeeping module carried by the body, wherein the housekeeping module is configured to perform a housekeeping operation;
wherein the housekeeping module is extendible from the underside of the body.

2. The robot according to claim 1, wherein:
the robot is configured to tilt the housekeeping module relative to the underside from a stowed orientation to a deployed orientation such that:
in the stowed orientation a clearance space is formed between the housekeeping module and the support surface; and
tilting the housekeeping module from the stowed orientation to the deployed orientation causes at least a portion of the housekeeping module to be extended towards the support surface.

3. The robot according to claim 2, wherein:
the robot is configured to lower the body towards the support surface to urge the housekeeping module against the support surface, thereby causing the housekeeping module to tilt from the deployed orientation to the stowed orientation; and
the housekeeping module and the body are configured to cooperate to releasably lock in the stowed orientation.

4. The robot according to claim 2, wherein:
the robot is configured to enter a first operational mode by tilting the housekeeping module to the deployed orientation to cause the housekeeping module to engage the support surface.

5. The robot according to claim 4, wherein:
in the first operational mode the robot is configured to translate the housekeeping module along a longitudinal axis of the body between a retracted position and an extended position, thereby causing the housekeeping module to move along the support surface.

6. The robot according to claim 1, wherein:
the robot is configured to translate the housekeeping module along a longitudinal axis of the body between a retracted position and an extended position; and
a length of the robot along the longitudinal axis is greater when the housekeeping module is in the extended position than when the housekeeping module is in the retracted position.

7. The robot according to claim 6, wherein:
the housekeeping module is configured to be translated to the extended position so as to increase the extent by which the housekeeping module extends from a front end of the body;
the robot is configured to assume a sitting configuration in which the body is tilted such that the front end of the body is supported at a higher elevation than a rear end of the body relative to the support surface, and
the robot is configured to have the housekeeping module in the extended position when the robot assumes the sitting configuration.

8. The robot according to claim 6, wherein:
the robot is configured to translate the housekeeping module to the extended position to expose to user access a release mechanism for releasing the housekeeping module.

9. The robot according to claim 6, wherein:
the robot is configured to lower the body towards the support surface to cause the robot to assume a lowered configuration; and
the robot is configured to enter a second operational mode by assuming the lowered position and translating the housekeeping module to the extended position.

10. The robot according to claim 1, wherein:
the robot comprises a port configured to releasably receive the housekeeping module such that the housekeeping module can be exchanged for another housekeeping module.

11. The robot according to claim 1, wherein:
the plurality of legs comprises a pair of front legs facing in a forward direction;
the housekeeping module includes a module body and a module head;
the module body extends in the forward direction through a gap between the pair of front legs; and
the module head of the housekeeping module is located in front of the pair of front legs and is wider than the gap.

12. The robot according to claim 1, wherein:
the robot is a quadruped;
each leg includes a leg joint that can bend;
the robot is configured to lower the body towards the support surface, by bending the leg joints, to assume a lowered configuration; and
the leg joint of each leg of the robot is arranged to move inward with respect to the body when the robot assumes the lowered configuration.

13. The robot according to claim 1, wherein the housekeeping module is provided as a vacuum cleaning module, a wet cleaning module, a watering module, a lawnmowing module, or a leaf-blowing module.

14. A robot system, comprising:
a robot according to claim 1, and
a module station configured to receive the housekeeping module;
wherein the robot is configured to approach the module station and release the housekeeping module so as to transfer the housekeeping module to the module station.

15. The robot system according to claim 14, further comprising:
one or more other housekeeping modules;
wherein the robot is configured to exchange the housekeeping module for the one or more other housekeeping modules at the module station.
